(19) United States
(12) Patent Application Publication
(10) Pub. No.: US 2017/0265071 A1
(43) Pub. Date: Sep. 14, 2017

(54) IDENTITY RECOGNITION METHOD, TRANSMITTER, RECEIVER, WEARABLE DEVICE AND IDENTITY RECOGNITION SYSTEM

(71) Applicant: BOE TECHNOLOGY GROUP CO., LTD., Beijing (CN)

(72) Inventor: Jian GAO, Beijing (CN)

(73) Assignee: BOE TECHNOLOGY GROUP CO., LTD., Beijing (CN)

(21) Appl. No.: 15/308,693

(22) PCT Filed: Mar. 2, 2016
(86) PCT No.: PCT/CN2016/075372

§ 371 Date: Nov. 3, 2016

(30) Foreign Application Priority Data
Sep. 8, 2015 (CN) 201510568227.0

(51) Int. Cl. H04W 12/06; G06F 17/30; H04B 1/3827; H04L 29/06

(52) U.S. Cl. CPC H04W 12/06; H04L 63/0853; G06F 17/30864; H04B 1/385

(57) ABSTRACT

An identity recognition method, a transmitter, a receiver, a wearable device applied to identity recognition, and an identity recognition system are provided. The method comprises acquiring, by a transmitter, identity characteristic information of a user to be recognized, the identity characteristic information uniquely identifying an identity of the user to be recognized, converting, by the transmitter, the identity characteristic information into a digital signal, transmitting, by the transmitter, the digital signal to a receiver in a wireless manner, such that the receiver extracts the identity characteristic information of the user to be recognized from the digital signal and performs identity recognition on the user to be recognized according to the identity characteristic information.

### CROSS-REFERENCE TO RELATED APPLICATIONS

The present application claims priority to Chinese Patent Application No. 201510568227.0 filed on Sep. 8, 2015, the disclosure of which is incorporated in its entirety by reference herein.

### TECHNICAL FIELD

The present disclosure relates to the field of identity recognition technology, in particular to an identity recognition method, a transmitter, a receiver, a wearable device and an identity recognition system.

### BACKGROUND

Recognition techniques such as iris recognition and fingerprint recognition are widely applied to various identity recognition or identity authentication scenes. When performing fingerprint recognition, a user should locate his/her finger within a sensing region specified for an acquisition device, such that fingerprint information of the user can be acquired by the acquisition device. Then the acquisition device compares the fingerprint information of the user with pieces of fingerprint information in a preset fingerprint information database and determines an identity of the user.

However, during the above process, identity characteristic information of the user, i.e., the fingerprint information may be left on the acquisition device; thus, the identity characteristic information of the user is likely to be imitated by another person and the user is in risk of information security problems.

### SUMMARY

Embodiments of the present disclosure provide an identity recognition method, a transmitter, a receiver and a wearable device applied to identity recognition, and an identity recognition system, with which leakage of user information is avoided in a certain extent during an identity recognition process and security of identity recognition is improved.

In order to achieve above purposes, following technical solutions are provided in the embodiments of the present disclosure.

In one aspect, some embodiments of the present disclosure provide an identity recognition method, which includes: acquiring, by a transmitter, identity characteristic information of a user to be recognized, wherein the identity characteristic information uniquely identifies an identity of the user to be recognized; converting, by the transmitter, the identity characteristic information into a digital signal; transmitting, by the transmitter, the digital signal to a receiver in a wireless manner, such that the receiver extracts the identity characteristic information of the user to be recognized from the digital signal and performs identity recognition on the user to be recognized according to the identity characteristic information.

Optionally, the step of converting, by the transmitter, the identity characteristic information into the digital signal may include: converting, by the transmitter, the identity characteristic information into an electrical digital signal carried on an electrical signal via analog-to-digital conversion; and converting, by the transmitter, the electrical digital signal into an optical digital signal carried on an optical signal via electrical-to-optical conversion.

Optionally, after the step of converting, by the transmitter, the identity characteristic information into the electrical digital signal carried on the electrical signal via analog-to-digital conversion, the method may further include: encrypting, by the transmitter, the electrical digital signal.

Optionally, the identity characteristic information includes at least one of: heart rate information, vein characteristic information, fingerprint information, voice information, and iris information.

Optionally, the step of transmitting, by the transmitter, the digital signal to the receiver may include: carrying, by the transmitter, the digital signal in a first instruction triggered by the user to be recognized, the first instruction being used to indicate the receiver to execute a program corresponding to the first instruction; and transmitting, by the transmitter, the first instruction to the receiver.

In another aspect, some embodiments of the present disclosure provide an identity recognition method, which includes: receiving, by a receiver in a wireless manner, a digital signal from a transmitter; extracting, by the receiver, identity characteristic information of a user to be recognized from the digital signal, where the identity characteristic information uniquely identifies an identity of the user to be recognized; and searching, by the receiver, a pre-stored characteristic database to determine whether there exists first identity characteristic information matching the identity characteristic information in the pre-stored characteristic database, and authenticating the identity of the user to be recognized in the case that there exists the first identity characteristic information matching the identity characteristic information in the pre-stored characteristic database.

Optionally, the step of receiving, by the receiver, the digital signal from the transmitter may include: receiving, by the receiver, a first instruction sent by the transmitter, where the digital signal is carried in the first instruction. After the step of authenticating the identity of the user to be recognized in the case that there exists the first identity characteristic information matching the identity characteristic information in the pre-stored characteristic database, the method may further include: executing, by the receiver, a program corresponding to the first instruction.

In another aspect, some embodiments of the present disclosure provide a transmitter, which includes: an acquisition unit, configured to acquire identity characteristic information of a user to be recognized, where the identity characteristic information uniquely identifies an identity of the user to be recognized; a conversion unit, configured to convert the identity characteristic information into a digital signal; and a transmitting unit, configured to transmit the digital signal to a receiver in a wireless manner, such that the receiver extracts the identity characteristic information of the user to be recognized from the digital signal and performs identity recognition on the user to be recognized according to the identity characteristic information.

Optionally, the conversion unit is configured to convert the identity characteristic information into an electrical digital signal carried on an electrical signal via analog-to-digital conversion, and convert the electrical digital signal into an optical digital signal carried on an optical signal via electrical-to-optical conversion; or the conversion unit is configured to convert the identity characteristic information into an electrical digital signal carried on an electrical signal via analog-to-digital conversion.

Optionally, the transmitter may further include an encryption unit, configured to encrypt the electrical digital signal.

Optionally, the transmitter may further include an adding unit. The adding unit is configured to carry the digital signal in a first instruction triggered by the user to be recognized, the first instruction being used to indicate the receiver to execute a program corresponding to the first instruction; and the transmitting unit is configured to transmit the first instruction to the receiver.

Optionally, the transmitter may be a wearable device.

In another aspect, some embodiments of the present disclosure provide a receiver, which includes: a receiving unit, configured to receive a digital signal from a transmitter; an extraction unit, configured to extract identity characteristic information of a user to be recognized from the digital signal, where the identity characteristic information uniquely identifies an identity of the user to be recognized; and a recognition unit, configured to search a pre-stored characteristic database to determine whether there exists first identity characteristic information matching the identity characteristic information in the pre-stored characteristic database, and authenticate the identity of the user to be recognized in the case that there exists the first identity characteristic information matching the identity characteristic information in the pre-stored characteristic database.

Optionally, the transmitter may further include an execution unit. The receiving unit is configured to receive a first instruction from the transmitter, where the digital signal is carried in the first instruction; and the execution unit is configured to execute a program corresponding to the first instruction.

In another aspect, some embodiments of the present disclosure provide a wearable device, which includes: a processor, a first sensor, a second sensor and a transceiver. The first sensor, the second sensor and the transceiver each are connected to the processor. The first sensor is arranged on a first surface of the wearable device via which the wearable device is in contact with skin of a user, and the second sensor is arranged on a surface opposite to the first surface. The first sensor and the second sensor are configured to acquire identity characteristic information of a user to be recognized, where the identity characteristic information uniquely identifies an identity of the user to be recognized. The processor is configured to convert the identity characteristic information into a digital signal. The transceiver is configured to transmit the digital signal to a receiver in a wireless manner, such that the receiver extracts the identity characteristic information of the user to be recognized from the digital signal and performs identity recognition on the user to be recognized according to the identity characteristic information.

Optionally, the processor is configured to convert the identity characteristic information into an electrical digital signal carried on an electrical signal via analog-to-digital conversion, and convert the electrical digital signal into an optical digital signal carried on an optical signal via electrical-to-optical conversion; or the processor is configured to convert the identity characteristic information into an electrical digital signal carried on an electrical signal via analog-to-digital conversion.

Optionally, the processor may be further configured to encrypt the electrical digital signal.

Optionally, the wearable device may further include a display, which is arranged on the surface opposite to the first surface and configured to display the identity characteristic information of the user to be recognized.

Optionally, the wearable device may further include a storage, which is connected to each of the processor, the first sensor and the second sensor.

In another aspect, some embodiments of the present disclosure provide an identity recognition system, which includes the transmitter described above and the receiver described above, where the transmitter and the receiver are in communication with each other in a wireless manner and the transmitter is separated from the receiver.

The embodiments of the present disclosure provide an identity recognition method, a transmitter, a receiver, a wearable device, and an identity recognition method. The transmitter acquires identity characteristic information of a user to be recognized, where the identity characteristic information uniquely identifies an identity of the user to be recognized. Then the transmitter converts the identity characteristic information into a digital signal and transmits the digital signal to the receiver in a wireless manner, such that the receiver extracts the identity characteristic information of the user to be recognized from the digital signal and performs identity recognition on the user to be recognized according to the identity characteristic information. In this way, the transmitter is separated from the receiver, i.e., the transmitter and the receiver are not integrated together, and the transmitter for acquiring identity characteristic information of a user is movable with respect to the receiver for identity recognition. Thus, when the transmitter and receiver interact with each other for performing identity recognition, the transmitter may carry the identity characteristic information of the user in a digital signal and may transmit the digital signal in a wireless manner to the receiver for identity recognition, such that the identity characteristic information of the user is not left on the receiver for recognizing the identity, and leakage of user information is avoided during an identity recognition process, thereby improving security of identity recognition.

### BRIEF DESCRIPTION OF THE DRAWINGS

In order to explain the technical solutions in the embodiments of the present disclosure more clearly, accompany drawings used in these embodiments are briefly introduced hereinafter. Apparently, the drawings described hereinafter are only for some embodiments of the present disclosure, and other drawings may be obtained by those skilled in the art based on the described drawings without creative efforts.

FIG. 1 is a schematic flow chart of an identity recognition method according to some embodiments of the present disclosure;

FIG. 2 is a schematic flow chart of an identity recognition method according to some embodiments of the present disclosure;

FIG. 3 is a schematic flow chart of an identity recognition method according to some embodiments of the present disclosure;

FIG. 4 is a schematic structural diagram of a transmitter according to some embodiments of the present disclosure;

FIG. 5 is a schematic structural diagram of a transmitter according to some embodiments of the present disclosure;

FIG. 6 is a schematic structural diagram of a transmitter according to some embodiments of the present disclosure;

FIG. 7 is a schematic structural diagram of a receiver according to some embodiments of the present disclosure;

FIG. 8 is a schematic structural diagram of a receiver according to some embodiments of the present disclosure;

FIG. 9 is a schematic structural diagram of a receiver according to some embodiments of the present disclosure;

FIG. 10 is a schematic structural diagram of a wearable device according to some embodiments of the present disclosure;

FIG. 11 is a schematic structural diagram of a wearable device according to some embodiments of the present disclosure;

FIG. 12 is a schematic structural diagram of a wearable device according to some embodiments of the present disclosure;

FIG. 13a is a front view of a wearable watch according to some embodiments of the present disclosure;

FIG. 13b is a top view of the wearable watch in the FIG. 13a; and

FIG. 14 is a schematic structural diagram of an identity recognition system according to some embodiments of the present disclosure

### DETAILED DESCRIPTION

In the following description, for purposes of explanation rather than limitation, specific details such as particular system architectures, interfaces, techniques, etc., are set forth in order to provide thorough understanding of the present disclosure. However, it will be appreciated by the skilled in the art that the present disclosure may be practiced in other embodiments without these specific details. In addition, detailed descriptions about well-known devices, circuits and methods are omitted so as to avoid redundant and unnecessary details in description of the present disclosure.

Terms such as “first” and “second” are used herein for purposes of description and are not intended to indicate or imply relative importance or refer to the quantity of any indicated technical characteristic. Therefore, it is indicated or implied that the quantity of a characteristic limited by the term “first” or “second” may be one or plural. In the description of the present disclosure, unless indicated otherwise, the term “multiple” means two or more than two.

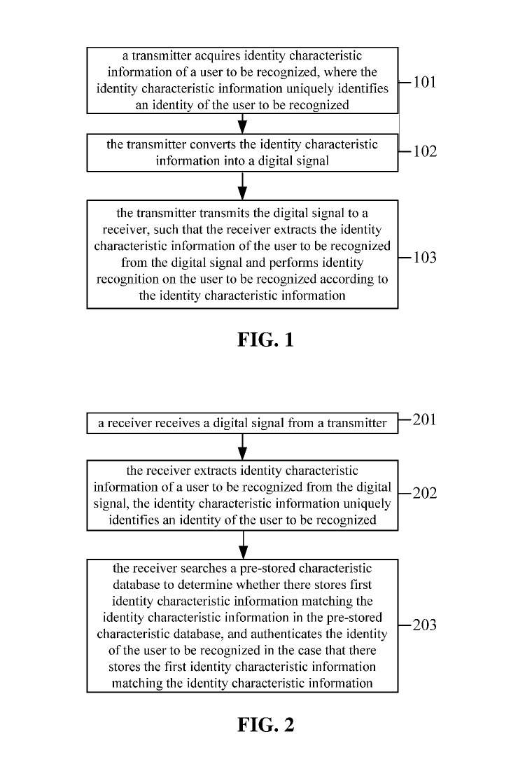

Some embodiments of the present disclosure provide an identity recognition method. As shown in FIG. 1, the method includes the following steps 101 to 103.

In step 101, a transmitter acquires identity characteristic information of a user to be recognized, where the identity characteristic information uniquely identifies an identity of the user to be recognized.

In step 102, the transmitter converts the identity characteristic information into a digital signal.

In step 103, the transmitter transmits the digital signal to a receiver, such that the receiver extracts the identity characteristic information of the user to be recognized from the digital signal and performs identity recognition on the user to be recognized according to the identity characteristic information.

Specifically, the transmitter in embodiments of the present disclosure may be a wearable device such as a wearable watch, a wearable bracelet and a wearable helmet, etc. The transmitter may alternatively be a mobile phone, a tablet computer, a notebook computer, an ultra-mobile personal computers (UMPC), a net book or a personal digital assistant (PDA), which is not limited in the embodiments of the present disclosure.

Similarly, the receiver in the embodiments of the present disclosure may be a mobile phone, a tablet computer, a notebook computer, a UMP, a net book or a PDA, which is not limited in the embodiments of the present disclosure.

Specifically, when the identity of the user needs to be recognized by the receiver, the user may get the identity characteristic information acquired by the transmitter and the transmitter transmits the identity characteristic information to the receiver, and then the receiver performs identity recognition on the user to be recognized according to the identity characteristic information. In this way, the identity characteristic information is prevented from being left on the transmitter and consequently information security problems are avoided.

In the step 101, the transmitter can acquire identity characteristic information of the user to be recognized through various sensors. Here the identity characteristic information uniquely identifies the identity of the user to be recognized. It should be noted that, the identity characteristic information uniquely identifies the identity of the user means that the identity characteristic information has a unique identification function within a certain range such as a family, a company and the like.

Specifically, the identity characteristic information includes at least one of: heart rate information, vein characteristic information, fingerprint information, voice information, and iris information.

Moreover, at least one sensor may be arranged in the transmitter to acquire the identity characteristic information of the user to be recognized. For example, a temperature sensor and a fingerprint sensor are arranged in the transmitter, temperature information of the user to be recognized may be acquired by the temperature sensor and fingerprint information of the user to be recognized may be acquired by the fingerprint sensor; in this case, the identity characteristic information of the user to be recognized includes the temperature information and the fingerprint information. Since the identity characteristic information is able to uniquely identify the identity of the user to be recognized, the acquired identity characteristic information is consequently used in identity recognition performed on the user to be recognized.

Optionally, identity characteristic information of a user to be recognized, such as fingerprint information and voice information, can be directly pre-stored in the transmitter, such that the transmitter can directly obtain the identity characteristic information of the user to be recognized from a storage unit of the transmitter rather than obtain the identity characteristic information of the user to be recognized through various sensors. The user to be recognized may store his/her identity characteristic information in the transmitter, and when an identity of the user needs to be authenticated, the transmitter only needs to find the pre-stored identity characteristic information from the storage unit of the transmitter.

In the step 102, the transmitter converts the identity characteristic information acquired in the step 101 into a digital signal.

Specifically, since the identity characteristic information acquired by the sensor is generally an analog signal, and the analog signal should be converted into a digital signal so as to be transmitted during an interaction between the transmitter and the receiver, the transmitter may convert the identity characteristic information into an electrical digital signal via analog-to-digital conversion, where the electrical digital signal is carried on an electrical signal. Furthermore, the transmitter may convert the electrical digital signal into an optical digital signal via electrical-to-optical conversion, where the optical digital signal is carried on an optical signal.

Due to advantages of the optical communication manner with optical signal as a carrier signal, such as, better confidentiality, larger information capacity and lower cost, preferably, the transmitter converts the identity characteristic information into the optical digital signal that is carried on the optical signal, and sends the optical digital signal to the receiver.

Optionally, the transmitter may directly convert the identity characteristic information into the electrical digital signal that is carried on the electrical signal, and then sends the electrical digital signal to the receiver. Since the electrical digital signal contains the identity characteristic information, the receiver can still extract the identity characteristic information of the user to be recognized from the electrical digital signal and perform identity recognition.

In the step 103, the transmitter sends the digital signal (for example, the optical digital signal) generated in the step 102 to the receiver, such that the receiver extracts the identity characteristic information of the user to be recognized from the digital signal. Because the identity characteristic information uniquely identifies the identity of the user to be recognized, the receiver can perform identity recognition on the user to be recognized according to the identity characteristic information.

Specifically, when the digital signal generated in the step 102 is the optical digital signal, the optical signal carrying the optical digital signal may be visible light or invisible light.

Some embodiments of the present disclosure provide an identity recognition method. As shown in FIG. 2, the method includes the following steps 201 to 203.

In step 201, a receiver receives a digital signal from a transmitter.

In step 202, the receiver extracts identity characteristic information of a user to be recognized from the digital signal, the identity characteristic information uniquely identifies an identity of the user to be recognized.

In step 203, the receiver searches a pre-stored characteristic database to determine whether there stores first identity characteristic information matching the identity characteristic information in the pre-stored characteristic database, and authenticates the identity of the user to be recognized in the case that there stores the first identity characteristic information matching the identity characteristic information in the pre-stored characteristic database.

In the step 201, the receiver receives the digital signal, such as an optical digital signal carried on an optical signal or an electrical digital signal carried on an electrical signal, from the transmitter; and the digital signal carries the identity characteristic information of the user to be recognized, such as, heart rate information, vein information, voice information, etc.

In the step 202, the receiver extracts the identity characteristic information of the user to be recognized from the digital signal received in the step 201, where the identity characteristic information uniquely identifies the identity of the user to be recognized.

Specifically, an approach with which the receiver extracts the identity characteristic information of the user to be recognized may be the same as an inverse operation of converting the identity characteristic information into the digital signal in the step 102.

For example, in the case that the digital signal received in the step 201 is the optical digital signal, the receiver may convert the optical digital signal into an electrical digital signal carried on an electrical signal via optical-to-electrical conversion, and then the receiver converts the electrical digital signal into the identity characteristic information of the user to be recognized via digital-to-analog conversion.

In the step 203, the receiver searches the pre-stored characteristic database to determine whether there exists first identity characteristic information matching the identity characteristic information extracted in the step 202 in the pre-stored characteristic database.

Specifically, a characteristic database is pre-stored in the receiver, and identity characteristic information of multiple users is stored in the characteristic database. In general, various items of identity characteristic information of each authenticated user, such as fingerprint information, pulse information, voice information, heart rate information and iris information are stored in the characteristic database, and an information item included in the extracted identity characteristic information is a subset of information items included in identity characteristic information stored in the characteristic database. If the identity characteristic information extracted in the step 202 includes multiple information items, such as, fingerprint information and pulse information, it is determined that the identity characteristic information of the user to be recognized matches first identity characteristic information of a first user in the characteristic database, and the identity of the user to be recognized is authenticated by the receiver in the following condition: when the receiver compares identity characteristic information in the characteristic database with the identity characteristic information extracted in the step 202 and finds that at least one information stem of multiple information items included in the identity characteristic information extracted in the step 202 is the same as at least one corresponding information item of the first identity characteristic information of the first user in the characteristic database, or the similarity between at least one information stem of multiple information items included in the identity characteristic information extracted in the step 202 and at least one corresponding information item of the first identity characteristic information of the first user in the characteristic database is greater than a threshold (for example, 98%). In some other embodiments, the identity characteristic information extracted in the step 202 includes only one information item; correspondingly, it is determined that the identity characteristic information of the user to be recognized matches first identity characteristic information of a first user in the characteristic database, and the identity of the user to be recognized is authenticated by the receiver in the following condition: the receiver finds that the information stem included in the identity characteristic information extracted in the step 202 is the same as one information item of the first identity characteristic information of the first user in the characteristic database, or the similarity between the information stem included in the identity characteristic information extracted in the step 202 and one information item of the first identity characteristic information of the first user in the characteristic database is greater than a threshold (for example, 98%).

Further, a correspondence between identity characteristic information of each authenticated user and a corresponding identification of the authenticated user may be stored in the characteristic database. Accordingly, if the identity characteristic information extracted in the step 202 includes multiple information items, the receiver can determine that the user to be recognized is a first authenticated user when the receiver finds at least one information stem of the multiple information items included in the identity characteristic information extracted in the step 202 is the same as at least one corresponding information item of the identity characteristic information of the first authenticated user in the characteristic database; if the identity characteristic information extracted in the step 202 includes only one information item, the receiver can determine that the user to be recognized is a first authenticated user when the receiver finds the information stem included in the identity characteristic information extracted in the step 202 is the same as the corresponding information item of the identity characteristic information of the first authenticated user in the characteristic database.

In view of this, the embodiments of the present disclosure provide an identity recognition method, where the transmitter acquires identity characteristic information of a user to be recognized, the identity characteristic information uniquely identifies an identity of the user to be recognized; and then the transmitter converts the identity characteristic information into a digital signal and sends the digital signal to the receiver, such that the receiver extracts the identity characteristic information of the user to be recognized from the digital signal and performs identity recognition on the user to be recognized according to the identity characteristic information. In this way, the transmitter is separated from the receiver, i.e., the transmitter and the receiver are not integrated together; consequently, the transmitter for acquiring identity characteristic information of the user is movable with respect to the receiver for identity recognition. Thus, when the transmitter and receiver interact with each other for performing identity recognition, the transmitter may carry the identity characteristic information of the user on the digital signal and may send the digital signal in a wireless manner to the receiver for identity recognition, such that the identity characteristic information of the user is not left on the receiver for identity recognition, and leakage of user information can be avoided during the identity recognition, thereby improving security of identity recognition.

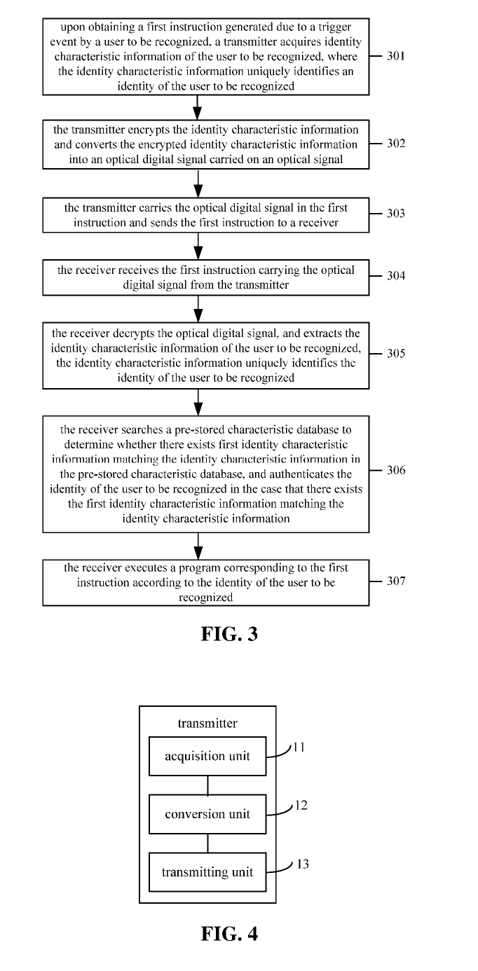

Some embodiments of the present disclosure provide an identity recognition method. As shown in FIG. 3, the method includes the following steps 301 to 307.

In step 301, upon obtaining a first instruction generated due to a trigger event by a user to be recognized, a transmitter acquires identity characteristic information of the user to be recognized, where the identity characteristic information uniquely identifies an identity of the user to be recognized.

In step 302, the transmitter encrypts the identity characteristic information and converts the encrypted identity characteristic information into an optical digital signal carried on an optical signal.

In step 303, the transmitter carries the optical digital signal in the first instruction and sends the first instruction to a receiver.

In step 304, the receiver receives the first instruction carrying the optical digital signal from the transmitter.

In step 305, the receiver decrypts the optical digital signal, and extracts the identity characteristic information of the user to be recognized, the identity characteristic information uniquely identifies the identity of the user to be recognized.

In step 306, the receiver searches a pre-stored characteristic database to determine whether there exists first identity characteristic information matching the identity characteristic information in the pre-stored characteristic database, and authenticates the identity of the user to be recognized in the case that there exists the first identity characteristic information matching the identity characteristic information in the pre-stored characteristic database.

In step 307, the receiver executes a program corresponding to the first instruction according to the identity of the user to be recognized.

In the step 301, when the user to be recognized triggers a corresponding function key of the transmitter, the transmitter generates a corresponding first instruction, where the first instruction is used to indicate the receiver to execute a program corresponding to the first instruction.

For example, when the user to be recognized clicks a button within a screen of the transmitter, the button being for remotely controlling the receiver to perform a clocking-in, the transmitter is triggered to generate a first instruction to indicate the receiver to perform a clocking-in program.

Here, the transmitter can acquire identity characteristic information of the user to be recognized through various sensors and the identity characteristic information uniquely identifies the identity of the user to be recognized.

The identity characteristic information may include at least one of: heart rate information, vein characteristic information, fingerprint information, voice information, and iris information.

In the step 302, the transmitter converts the identity characteristic information acquired in the step 301 into the optical digital signal carried on the optical signal.

Specifically, in order to improve reliability and confidentiality of optical digital signal transmission, the transmitter may convert the identity characteristic information into an electrical digital signal carried on an electrical signal via analog-to-digital conversion, and then the transmitter may encrypt the electrical digital signal in a modulation manner and converts the encrypted electrical digital signal into an optical digital signal carried on an optical signal via electrical-to-optical conversion.

In the step 303, the transmitter carries the optical digital signal obtained in the step 302 in the first instruction, and transmits the first instruction to the receiver, such that the receiver can extract the identity characteristic information of the user to be recognized according to the first instruction, and executes a program corresponding to the first instruction in the case that the identity of the user to be recognized is authenticated.

As can be seen, by performing the steps 301 to 303, the transmitter encrypts the identity characteristic information of the user to be recognized, carries the identity characteristic information in the optical digital signal carried on the optical signal, and transmits the optical digital signal to the receiver via an optical directional transmission for identity recognition; thus, the identity characteristic information of the user may no longer be left on the acquisition device, and therefore the security of the identity recognition is improved.

Further, in the step 304, the receiver receives the first instruction transmitted by the transmitter in the step 303, where the optical digital signal is carried in the first instruction.

In the step 305, the receiver extracts the identity characteristic information of the user to be recognized from the optical digital signal, where the identity characteristic information uniquely identifies the identity of the user to be recognized.

Specifically, the receiver may convert the optical digital signal into an electrical digital signal carried on an electrical signal via optical-to-electrical conversion. Since the electrical digital signal is encrypted through the modulation manner in the step 302, the receiver may decrypt the encrypted electrical optical signal through a demodulation manner, and then convert the electrical optical signal into the identity characteristic information of the user to be recognized via digital-to-analog conversion.

In the step 306, various items of identity characteristic information of each authenticated user are stored in the characteristic database, and an information item included in the identity characteristic information extracted in the step 305 is a subset of information items included in identity characteristic information stored in the characteristic database. Since a correspondence between identity characteristic information of each authenticated user and a corresponding identification of the authenticated user is stored in the characteristic database, if the identity characteristic information extracted in the step 305 includes multiple information items, the receiver can determine that the user to be recognized is a first authenticated user when the receiver finds at least one information item of the multiple information items included in the identity characteristic information extracted in the step 305 is the same as at least one corresponding information item of the identity characteristic information of the first authenticated user in the characteristic database; if the identity characteristic information extracted in the step 305 includes only one information item, the receiver can determine that the user to be recognized is a first authenticated user when the receiver finds the information item included in the identity characteristic information extracted in the step 305 is the same as the corresponding information item of the identity characteristic information of the first authenticated user in the characteristic database.

For example, the correspondence between the identification of the authenticated user and the identity characteristic information of the authenticated user is stored in the characteristic database, where the identity characteristic information of the authenticated user includes fingerprint information, pulse information, voice information, temperature information and iris information of the authenticated user. In the case that the identity characteristic information extracted in the step 305 includes fingerprint information, the fingerprint information is compared with fingerprint information included in the identity characteristic information of each authenticated user pre-stored in the characteristic database, and it is determined that the user to be recognized is a first authenticated user in the case that the fingerprint information included in the extracted identity characteristic information is the same as the fingerprint information of the first authenticated user.

Accordingly, if each of multiple information items of the identity characteristic information extracted in the step 305 is different from each corresponding information item of multiple information items included in the identity characteristic information of each authenticated user in the characteristic database, the identity of the user to be recognized cannot be authenticated, i.e., identity recognition fails; if the identity characteristic information extracted in the step 305 includes only one information item and the information item is different from the corresponding information item included in the identity characteristic information of each authenticated user in the characteristic database, the identity of the user to be recognized cannot be authenticated, i.e., identity recognition fails.

Or, the characteristic database may be stored in the transmitter. Thus, in the step 301, the transmitter may perform identity recognition on the user to be recognized after acquiring the identity characteristic information of the user to be recognized, and the transmitter does not need to transmit the first instruction to the receiver if the identity recognition about the user to be recognized fails.

Further, in the step 307, in the case that the identity of the user to be recognized is recognized successfully, the receiver may execute a program corresponding to the first instruction according to the identity of the user to be recognized.

Taking the example described in the step 301 for explanation, if the identity of the user to be recognized is recognized successfully, the receiver may perform a clocking-in process for the user to be recognized according to the first instruction indicating the receiver to perform a clocking-in program.

In above embodiments, illustration is made merely by taking a case that the digital signal is an optical digital signal for example. In other embodiments, the digital signal may be an electrical digital signal, i.e., an electrical-to-optical conversion is unnecessary and the electrical digital signal is encrypted and then carried in the first instruction, and the first instruction is transmitted to the receiver. Correspondingly, the receiver does not need to perform optical-to-electrical conversion and only needs to decrypt the encrypted electrical digital signal in the first instruction, and therefore obtains the identity characteristic information of the user to be recognized.

In view of the above, the embodiments of the present disclosure provide an identity recognition method. The transmitter acquires identity characteristic information of a user to be recognized, the identity characteristic information uniquely identifies an identity of the user to be recognized; and then the transmitter converts the identity characteristic information into a digital signal and transmits the digital signal to the receiver, such that the receiver extracts the identity characteristic information of the user to be recognized from the digital signal and performs identity recognition on the user to be recognize according to the identity characteristic information. In this way, the transmitter is separated from the receiver, i.e., the transmitter and the receiver are not integrated together, and the transmitter for acquiring identity characteristic information of a user is movable with respect to the receiver for identity recognition. Thus, when the transmitter and receiver interact with each other for identity recognition, the transmitter may carry the identity characteristic information of the user in a digital signal and may send the digital signal in a wireless manner to the receiver for identity recognition, such that the identity characteristic information of the user is not left on the receiver for identity recognition, and leakage of user information is avoided during an identity recognition process, thereby improving security of identity recognition.

FIG. 4 is a schematic structural diagram of a transmitter 01 in some embodiments of the present disclosure, and the transmitter 01 can be applied to implement the methods in the above embodiments of the present disclosure as shown in FIG. 1 to FIG. 3. For purpose of explanation, only contents relating to the embodiments are described, and specific technical details not described here may be obtained from the embodiments described in conjunction with FIG. 1 to FIG. 3.

The transmitter 01 may be a wearable device such as a wearable watch, a wearable bracelet, or a wearable helmet. Optionally, the transmitter 01 may be a mobile phone, a tablet computer, a notebook computer, a UMP, a net book or a PDA, which is not limited in embodiments of the present disclosure.

Specifically, as shown in FIG. 4, the transmitter 01 in some embodiments of the present disclosure includes: an acquisition unit 11, configured to acquire identity characteristic information of a user to be recognized, where the identity characteristic information uniquely identifies an identity of the user to be recognized; a conversion unit 12, configured to convert the identity characteristic information into a digital signal; and a transmitting unit 13, configured to transmit the digital signal to a receiver in a wireless manner, such that the receiver extracts the identity characteristic information of the user to be recognized from the digital signal and performs identity recognition on the user to be recognized according to the identity characteristic information.

Further, the conversion unit 12 is specifically configured to convert the identity characteristic information into an electrical digital signal carried on an electrical signal via analog-to-digital conversion, and convert the electrical digital signal into an optical digital signal carried on an optical signal via electrical-to-optical conversion. Here, the digital signal is the optical digital signal. Or the conversion unit 12 is configured to convert the identity characteristic information into an electrical digital signal carried on an electrical signal via analog-to-digital conversion; here, the digital signal is the electrical digital signal.

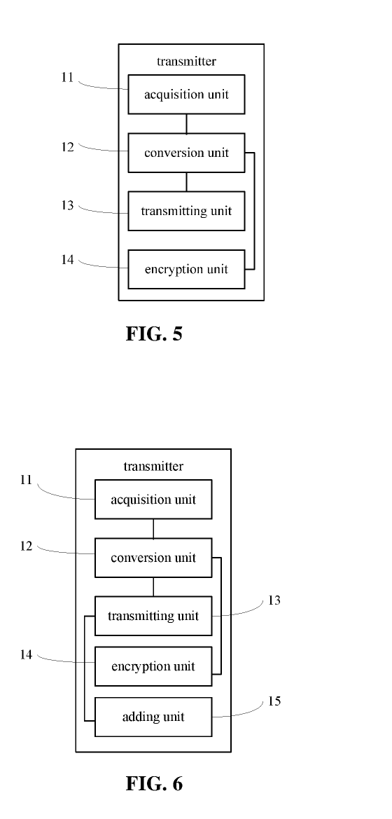

Further, in some embodiments, as shown in FIG. 5, the transmitter further includes an encryption unit 14, configured to encrypt the electrical digital signal.

Specifically, if the digital signal is the electrical digital signal, the encryption unit 14 encrypts the electrical digital signal after the analog-to-digital conversion; if the digital signal is the optical digital signal, the encryption unit 14 encrypts the optical digital signal after the analog-to-digital conversion and before the electrical-to-optical conversion.

Further, as shown in FIG. 6, the transmitter further includes an adding unit 15. The addition unit 15 is configured to carry the digital signal in a first instruction triggered by the user to be recognized, and the first instruction is used to indicate the receiver to execute a program corresponding to the first instruction. The transmitting unit 13 is specifically configured to transmit the first instruction to the receiver.

Optionally, the transmitter may be a wearable device.

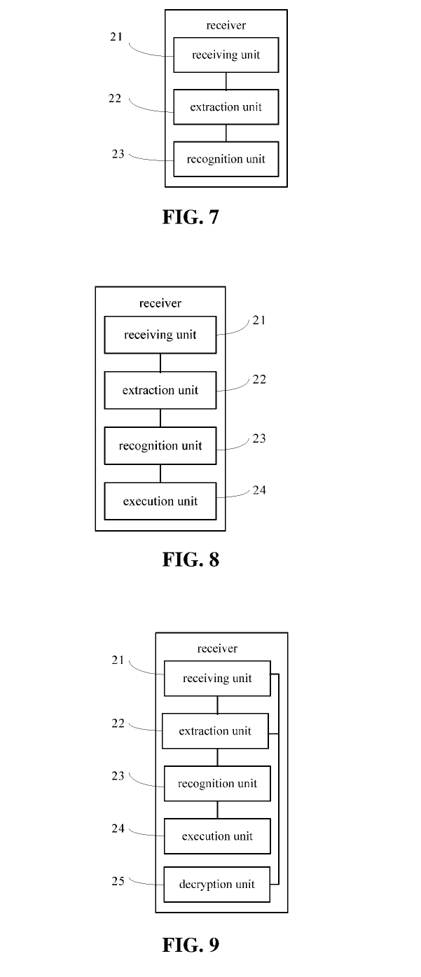

Further, FIG. 7 is a schematic structural diagram of a receiver 02 in some embodiments of the present disclosure, and the receiver 02 can be applied to implement the methods in the above embodiments of the present disclosure as shown in FIG. 1 to FIG. 3. For purpose of explanation, only contents relating to the embodiments are described, and specific technical details not described here may be obtained from the embodiments described in conjunction with FIG. 1 to FIG. 3.

The receiver 02 may be a mobile phone, a tablet computer, a notebook computer, a UMP, a net book or a PDA, which is not limited in the embodiments of the present disclosure.

Specifically, as shown in FIG. 7, the receiver 02 in some embodiments of the present disclosure includes: a receiving unit 21, configured to receive a digital signal from a transmitter; an extraction unit 22, configured to extract identity characteristic information of a user to be recognized from the digital signal, where the identity characteristic information uniquely identifies an identity of the user to be recognized; and a recognition unit 23, configured to search a pre-stored characteristic database to determine whether there exists first identity characteristic information matching the identity characteristic information in the pre-stored characteristic database, and authenticate the identity of the user to be recognized in the case that there exists the first identity characteristic information matching the identity characteristic information in the pre-stored characteristic database.

As shown in FIG. 8, the transmitter further includes an execution unit 24. The receiving unit 21 is specifically configured to receive a first instruction from the transmitter, where the digital signal is carried in the first instruction; and the execution unit 24 is configured to execute a program corresponding to the first instruction.

As shown in FIG. 9, the transmitter may further include a decryption unit 25, which is configured to decrypt the digital signal received by the receiving unit 21, such that the identity characteristic information of the user to be recognized can be extracted by the extraction unit 22 from the digital signal.

The embodiments of the present disclosure provide a transmitter and a receiver for identity recognition. The transmitter acquires identity characteristic information of a user to be recognized, the identity characteristic information uniquely identifies an identity of the user to be recognized; and then the transmitter converts the identity characteristic information into a digital signal and sends the digital signal to the receiver, such that the receiver extracts the identity characteristic information of the user to be recognized from the digital signal and performs identity recognition on the user to be recognized according to the identity characteristic information. In this way, the transmitter is separated from the receiver, i.e., the transmitter and the receiver are not integrated together, and the transmitter for acquiring identity characteristic information of a user is movable with respect to the receiver for identity recognition. Thus, when the transmitter and receiver interact with each other for identity recognition, the transmitter may carry the identity characteristic information of the user in the digital signal and may transmit the digital signal in a wireless manner to the receiver for identity recognition, such that the identity characteristic information of the user is not left on the receiver for recognizing the identity, and leakage of user information is avoided during an identity recognition process, thereby improving security of identity recognition.

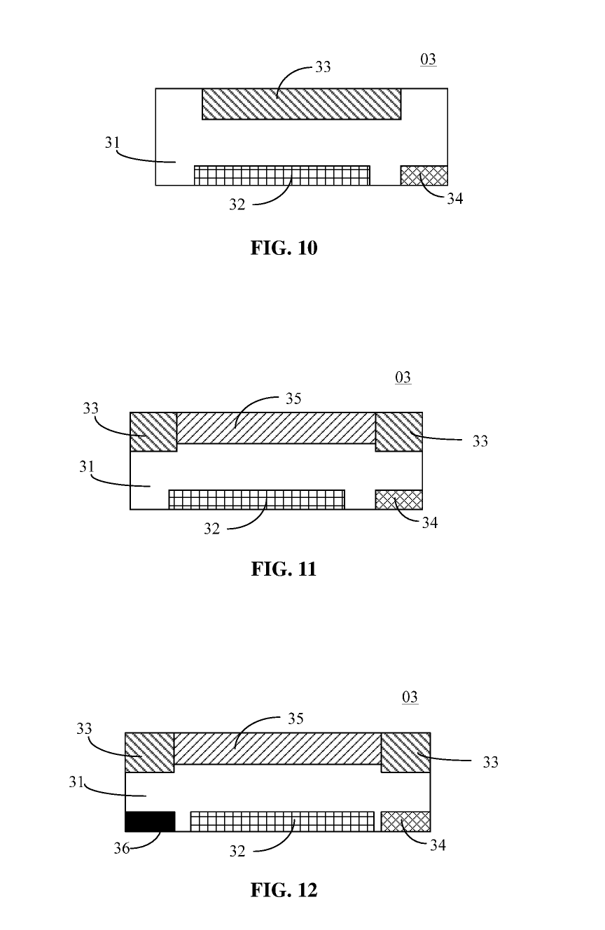

FIG. 10 is a schematic structural diagram of a wearable device 03 in some embodiments of the present disclosure, and the wearable device 03 can be applied to implement the methods in the above embodiments of the present disclosure. For purpose of explanation, only contents relating to the embodiments are described, and specific technical details not described here may be obtained from those embodiments described in conjunction with FIG. 1 to FIG. 3.

The wearable device 03 may be a wearable watch, a wearable bracelet, and a wearable helmet, etc., which is not limited in the embodiments of the present disclosure.

Specifically, as shown in FIG. 10, the wearable device 03 in some embodiments of the present disclosure includes a processor 31, and at least one first sensor 32, a second sensor 33 and a transceiver 34 that are connected to the processor 31.

Specifically, each first sensor 32 is disposed on a first surface, via which the wearable device is in contact with the skin of a user, and the second sensor 32 is disposed on a surface opposite to the first surface.

Specifically, the at least one first sensor 32 and the second sensor 33 are configured to acquire identity characteristic information of a user to be recognized, where the identity characteristic information uniquely identifies an identity of the user to be recognized. The conversion unit 31 is configured to convert the identity characteristic information into a digital signal, The transceiver 34 is configured to transmit the digital signal to a receiver in a wireless manner, such that the receiver extracts the identity characteristic information of the user to be recognized from the digital signal and performs identity recognition on the user to be recognized according to the identity characteristic information.

The identity characteristic information may include at least one of: heart rate information, vein characteristic information, fingerprint information, voice information, and iris information.

Optionally, the conversion unit 31 is configured to convert the identity characteristic information into an electrical digital signal carried on an electrical signal via analog-to-digital conversion, and convert the electrical digital signal into an optical digital signal carried on an optical signal via electrical-to-optical conversion. Or, the conversion unit 31 is configured to convert the identity characteristic information into an electrical digital signal carried on an electrical signal via analog-to-digital conversion.

The processor 31 is further configured to encrypt the electrical digital signal.

As shown in FIG. 11, the wearable device 03 further includes a display 35, which is also disposed on the surface opposite to the first surface and configured to display the identity characteristic information of the user to be recognized.

As shown in FIG. 12, the wearable device 03 further includes a storage 36 connected to the processor 31, the at least one first sensor 32 and the second sensor 33.

For example, the identity characteristic information of the user to be recognized, such as fingerprint information and voice information, can be directly pre-stored in the storage 36 of the wearable device. Hence, the wearable device can directly obtain the identity characteristic information of the user to be recognized from the storage 36 rather than through various sensors. In other words, a user to be recognized may store his/her identity characteristic information in the wearable device, and when an identity of the user needs to be authenticated, the wearable device only needs to find the pre-stored identity characteristic information from the storage 36.

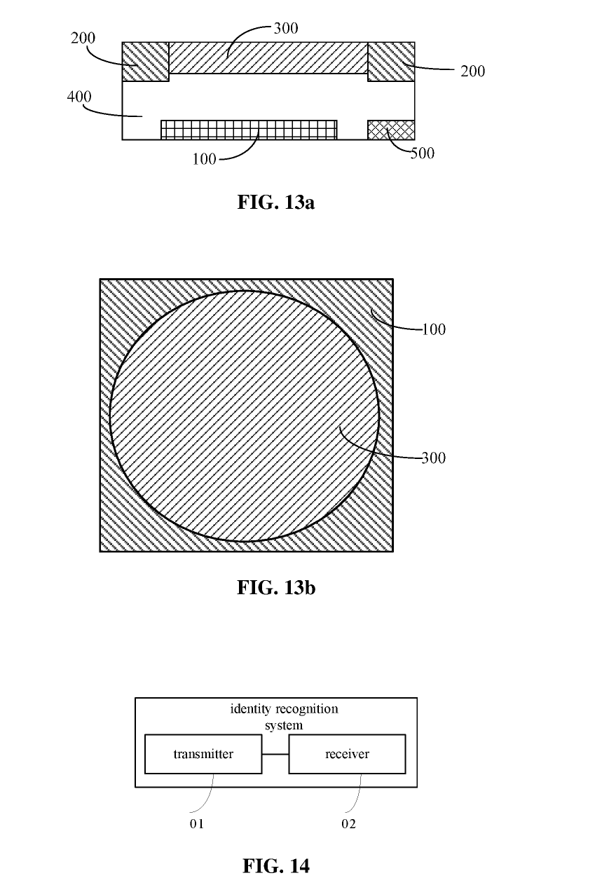

A wearable watch is taken for an example. The front view of the wearable watch is shown in FIG. 13a, and the top view of the wearable watch is shown in FIG. 13b.

The wearable watch includes: a first sensor 100, a second sensor 200, a display screen 300, a processor 400 and a transceiver 500, where the first sensor 100 is in contact with the skin at a wrist of a user to be recognized.

Since the first sensor 100 is in contact with the skin at the wrist of the user to be recognized, the first sensor 100 can be used to acquire identity characteristic information of the user to be recognized, such as, heart rate information, pulse information and temperature information, while the second sensor 200 can be used to acquire identity characteristic information of the user to be recognized, such as, fingerprint information and facial information.

Further, the first sensor 100 and the second sensor 100 transmit the acquired identity characteristic information to the processor 400, and then the processor 400 converts the identity characteristic information into an optical digital signal carried on an optical signal. The processor 400 may send the identity characteristic information to the display screen 300 for displaying. Finally, the processor 400 sends the optical digital signal to the receiver through the transceiver 500, such that the receiver extracts the identity characteristic information of the user to be recognized from the optical digital signal and performs identity recognition on the user to be recognized according to the identity characteristic information.

Further, FIG. 14 is a schematic structural diagram of an identity recognition system in some embodiments of the present disclosure, and the identity recognition system can be applied to implement the methods in the above embodiments of the present disclosure as shown in FIG. 1 to FIG. 3. For purpose of explanation, only contents relating to the embodiments are described, and specific technical details not described here may be obtained from those embodiments described in conjunction with FIG. 1 to FIG. 3.

Specifically, as shown in FIG. 11, the identity recognition system includes a transmitter 01 and a receiver 02 in data communication with the transmitter 01.

Specifically, the transmitter 01 and the receiver 02 communicate with each other in a wireless manner, and the transmitter 01 is separated from the receiver 02.

Specifically, as described in above embodiments, the transmitter 01 may be a wearable device such as a wearable watch, a wearable bracelet, or a wearable helmet, etc., which is not repeated in the embodiments of the present disclosure. The receiver 02 may be a mobile phone, a tablet computer, a notebook computer, a UMP, a net book or a PDA, etc., which is not repeated in the embodiments of the present disclosure.

In view of the above, the embodiments of the present disclosure provide a wearable device and an identity recognition system. The transmitter acquires identity characteristic information of a user to be recognized, the identity characteristic information uniquely identifies an identity of the user to be recognized; and then the transmitter converts the identity characteristic information into a digital signal and transmits the digital signal to the receiver, such that the receiver extracts the identity characteristic information of the user to be recognized from the digital signal and performs identity recognition on the user to be recognized according to the identity characteristic information. In this way, the transmitter is separated from the receiver, i.e., the transmitter and the receiver are not integrated together, and the transmitter for acquiring identity characteristic information of a user is movable with respect to the receiver for identity recognition. Thus, when the transmitter and receiver interact with each other for identity recognition, the transmitter may carry the identity characteristic information of the user in a digital signal and may send the digital signal in a wireless manner to the receiver for identity recognition, such that the identity characteristic information of the user is not left on the receiver for identity recognition, and leakage of user information is avoided during an identity recognition process, thereby improving security of identity recognition.

Throughout the description in the specification, the particular features, structures, materials or characteristics may be combined in any suitable manner in one or more embodiments.

As will be appreciated by one of skill in the art, the embodiments of the present disclosure may be embodied as methods, systems, or computer program products. Therefore, the embodiments herein can take the form of an entirely hardware embodiment, an entirely software embodiment or an embodiment including both hardware aspect and software aspect. Also, the present disclosure may take the form of a computer program product that is run through one or more computer-usable storage media (including, but not limited to, disk storage, CD-ROM, optical storage, and so forth) having computer-usable program code stored therein.

The present disclosure has been described with reference to the flow charts and/or block diagrams of the method, device (system) and computer program product according to the embodiments of the present disclosure. It should be understood that computer program instructions may be used to implement each of the work flows and/or blocks in the flow charts and/or the block diagrams, and the combination of the work flows and/or blocks in the flow charts and/or the block diagrams. These computer program instructions may be provided to a processor of a common computer, a dedicate computer, an embedded processor or any other programmable data processing devices to create a machine, so that instructions executable by the processor of the computer or the other programmable data processing devices may create a device to achieve the functions assigned in one or more work flows in the flow chart and/or one or more blocks in the block diagram.

These computer program instructions may also be stored in a computer readable storage that may guide the computer or the other programmable data processing devices to function in a certain way, so that the instructions stored in the computer readable storage may create a product including an instruction unit which achieves the functions assigned in one or more flows in the flow chart and/or one or more blocks in the block diagram.

These computer program instructions may also be loaded in the computer or the other programmable data processing devices, so that a series of operation steps are executed on the computer or the other programmable devices to create processes achieved by the computer. Therefore, the instructions executed in the computer or the other programmable devices provide the steps for achieving the function assigned in one or more flows in the flow chart and/or one or more blocks in the block diagram.

The above embodiments are only specific embodiments of the present disclosure, but the present disclosure is not limited thereto, and it will be apparent to those skilled in the art that various modifications or substitutions may be made without departing from the scope and spirit of the present disclosure, and these improvements and modifications shall also fall within the scope of the present disclosure. Therefore, the scope of the present disclosure is defined by the scope of the appended claims.

1. An identity recognition method, comprising:
acquiring, by a transmitter, identity characteristic information of a user to be recognized, wherein the identity characteristic information uniquely identifies an identity of the user to be recognized;
converting, by the transmitter, the identity characteristic information into a digital signal; and
transmitting, by the transmitter, the digital signal to a receiver in a wireless manner, such that the receiver extracts the identity characteristic information of the user to be recognized from the digital signal and performs identity recognition on the user to be recognized according to the identity characteristic information.

2. The method according to claim 1, wherein the step of converting, by the transmitter, the identity characteristic information into the digital signal comprises:
converting, by the transmitter, the identity characteristic information into an electrical digital signal carried on an electrical signal via analog-to-digital conversion; and
converting, by the transmitter, the electrical digital signal into an optical digital signal carried on an optical signal via electrical-to-optical conversion.

3. The method according to claim 2, wherein after the step of converting, by the transmitter, the identity characteristic information into the electrical digital signal carried on the electrical signal via analog-to-digital conversion, the method further comprises:
encrypting, by the transmitter, the electrical digital signal.

4. The method according to claim 1, wherein the identity characteristic information of the user to be recognized comprises at least one of: heart rate information, vein characteristic information, fingerprint information, voice information, and iris information.

5. The method according to claim 1, wherein the step of transmitting, by the transmitter, the digital signal to the receiver comprises:
carrying, by the transmitter, the digital signal in a first instruction triggered by the user to be recognized, the first instruction being used to indicate the receiver to execute a program corresponding to the first instruction; and
transmitting, by the transmitter, the first instruction to the receiver.

6. An identity recognition method, comprising:
receiving, by a receiver in a wireless manner, a digital signal from a transmitter;
extracting, by the receiver, identity characteristic information of a user to be recognized from the digital signal, wherein the identity characteristic information uniquely identifies an identity of the user to be recognized; and
searching, by the receiver, a pre-stored characteristic database to determine whether there exists first identity characteristic information matching the identity characteristic information in the pre-stored characteristic database, and authenticating the identity of the user to be recognized in the case that there exists the first identity characteristic information matching the identity characteristic information in the pre-stored characteristic database.

7. The method according to claim 6, wherein the step of receiving, by the receiver, the digital signal from the transmitter comprises:
receiving, by the receiver, a first instruction from the transmitter, wherein the digital signal is carried in the first instruction;
wherein after the step of authenticating the identity of the user to be recognized in the case that there exists the first identity characteristic information matching the identity characteristic information in the pre-stored characteristic database, the method further comprises:
executing, by the receiver, a program corresponding to the first instruction.

8. A transmitter, applied to identity recognition, comprising:
an acquisition unit, configured to acquire identity characteristic information of a user to be recognized, wherein the identity characteristic information uniquely identifies an identity of the user to be recognized;
a conversion unit, configured to convert the identity characteristic information into a digital signal; and
a transmitting unit, configured to transmit the digital signal to a receiver in a wireless manner, such that the receiver extracts the identity characteristic information of the user to be recognized from the digital signal and performs identity recognition on the user to be recognized according to the identity characteristic information.

9. The transmitter according to claim 8, wherein
the conversion unit is configured to convert the identity characteristic information into an electrical digital signal carried on an electrical signal via analog-to-digital conversion, and convert the electrical digital signal into an optical digital signal carried on an optical signal via electrical-to-optical conversion; or
the conversion unit is configured to convert the identity characteristic information into an electrical digital signal carried on an electrical signal via analog-to-digital conversion.

10. The transmitter according to claim 9, further comprising:
an encryption unit, configured to encrypt the electrical digital signal.

11. The transmitter according to claim 8, further comprising an adding unit configured to carry the digital signal in a first instruction triggered by the user to be recognized, the first instruction being used to indicate the receiver to execute a program corresponding to the first instruction; and
the transmitting unit is configured to transmit the first instruction to the receiver.

12. The transmitter according to claim 8, wherein the transmitter is a wearable device.

13. A receiver, applied to identity recognition, comprising:
a receiving unit, configured to receive a digital signal from a transmitter;
an extraction unit, configured to extract identity characteristic information of a user to be recognized from the digital signal, wherein the identity characteristic information uniquely identifies an identity of the user to be recognized; and
a recognition unit, configured to search a pre-stored characteristic database to determine whether there exists first identity characteristic information matching the identity characteristic information in the pre-stored characteristic database, and authenticate the identity of the user to be recognized in the case that there exists the first identity characteristic information matching the identity characteristic information in the pre-stored characteristic database.

14. The receiver according to claim 13, further comprising an execution unit, wherein
the receiving unit is configured to receive a first instruction from the transmitter, wherein the digital signal is carried in the first instruction; and
the execution unit is configured to execute a program corresponding to the first instruction.

15. A wearable device, applied to identity recognition, comprising: a processor, a first sensor, a second sensor and a transceiver; wherein each of the first sensor, the second sensor and the transceiver is connected to the processor, the first sensor is arranged on a first surface of the wearable device via which the wearable device is in contact with skin of a user, and the second sensor is arranged on a surface opposite to the first surface;
the first sensor and the second sensor are configured to acquire identity characteristic information of a user to be recognized, wherein the identity characteristic information uniquely identifies an identity of the user to be recognized;
the processor is configured to convert the identity characteristic information into a digital signal; and
the transceiver is configured to transmit the digital signal to a receiver in a wireless manner, such that the receiver extracts the identity characteristic information of the user to be recognized from the digital signal and performs identity recognition on the user to be recognized according to the identity characteristic information.

16. The wearable device according to claim 15, wherein
the processor is configured to convert the identity characteristic information into an electrical digital signal carried on an electrical signal via analog-to-digital conversion, and convert the electrical digital signal into an optical digital signal carried on an optical signal via electrical-to-optical conversion; or
the processor is configured to convert the identity characteristic information into an electrical digital signal carried on an electrical signal via analog-to-digital conversion.

17. The wearable device according to claim 16, wherein the processor is further configured to encrypt the electrical digital signal.

18. The wearable device according to claim 15, comprising a display that is arranged on the surface opposite to the first surface and configured to display the identity characteristic information of the user to be recognized.

19. The wearable device according to claim 15, further comprising a storage that is connected to each of the processor, the first sensor and the second sensor.

20. The wearable device according to claim 15, wherein the wearable device is a wearable watch.

21. (canceled)
